(19) United States
(12) Patent Application Publication
(10) Pub. No.: US 2021/0379776 A1
(43) Pub. Date: Dec. 9, 2021

(54) DUAL TANK BEARD CARE MULTI-TOOL

(71) Applicant: Andrew Newell, Fort Worth (US)

(72) Inventor: Andrew Newell, Fort Worth (US)

(21) Appl. No.: 16/896,086

(22) Filed: Jun. 8, 2020

(51) Int. Cl. B26B 13/24; A45D 24/02; A45D 42/04; A45D 34/00; A46B 9/02; A46B 15/00

(52) U.S. Cl. CPC B26B 13/24; A45D 24/02; A45D 42/04; A45D 34/00; A46B 9/023; A46B 2200/104; A46B 15/0065; A46B 15/0077; A46B 15/0095; A45D 2200/25; A46B 15/0059

(57) ABSTRACT

The dual tank beard care multi-tool disclosed herein is intended to be carried by a user and provide a mobile source of beard care grooming tools. The device provides two distinct tanks, one for oils and one for balms, and a plurality of tools required by beard wearers. Among these tools may be a switched beard comb, which may be manually or semi-automatically switched so that a user may carry the device without the comb teeth being exposed. The first tank and second tank may be integrated into the device main body or may be removably attached. The device may further comprise a plurality of receivers for receiving a folding comb, a scissor, and a beard brush. A mirror may also be installed within the device, and a heating element may be incorporated in some embodiments.

### TECHNICAL FIELD OF THE INVENTION

The present invention relates in general to multi-tool devices, and, more specifically, to a dual tank beard care multi-tool.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

A tool may be any object used by an individual to perform a function. Tools range widely in their composition and design based on their intended function. For example, a metal head may be attached relatively perpendicularly to a wooden or composite shaft to form a hammer, which may be used to drive one object into a second object. On the other hand, a metal tube having inlets for and supplies of air and fuel may form a torch, which may be used to heat up one or more other objects to be welded together or cut apart.

A multi-tool is, generally, a handheld device that combines two or more other tools into a compact form factor for ease of carrying and access, and may comprise tool attachments that are advantageous for the purpose of the multi-tool itself. One well known example, which may be known as a Swiss Army knife, is a multi-tool comprising a folding knife, screwdrivers, can openers, scissors, saws, and other various implements, and may be useful for outdoor uses and in survival situations.

Another composition of a multi-tool, which may be useful for bicyclists, may comprise a plurality of screwdrivers and wrenches commonly used for bicycle maintenance or repair in the field. A type of multi-tool, which may be known as a Leatherman tool, may, instead, comprise a folding knife and other implements while incorporating a needle nose plier. A significantly different type of multi-tool may simply comprise a flat section of material with various cutouts, which may be known as a card, and which may comprise tools for cutting, shearing, measuring, or opening other objects.

Proper beard grooming and beard care requires a plurality of tools. It is considered fundamental for proper beard care that a user at least have a beard comb, beard brush, beard oil, beard balm, and scissors. The inherent size and form factor of such tools, though, is not necessarily conducive to the carrying of such various tools by a user. Such tools may be made available in a smaller size or a travel size, but no solution exists to provide such various tools to a user in an outdoor setting or while away from home.

Thus, there is a need in the art for a dual tank beard care multi-tool that may be carried by a user so as to provide convenience of access to the various required beard grooming tools while in an outdoor setting or while away from home. It is to these ends that the present invention has been developed.

### BRIEF SUMMARY OF THE INVENTION

To minimize the limitations in the prior art, and to minimize other limitations that will be apparent upon reading and understanding the present specification, the present invention describes a dual tank beard care multi-tool.

It is an objective of the present invention to provide a dual tank beard care multi-tool that may comprise a plurality of tools.

It is another objective of the present invention to provide a dual tank beard care multi-tool that may comprise a plurality of beard care tools.

It is another objective of the present invention to provide a dual tank beard care multi-tool that may comprise a main body.

It is another objective of the present invention to provide a dual tank beard care multi-tool that may comprise an upper body.

It is another objective of the present invention to provide a dual tank beard care multi-tool that may comprise a lower body.

It is another objective of the present invention to provide a dual tank beard care multi-tool that may comprise a switch.

It is another objective of the present invention to provide a dual tank beard care multi-tool that may comprise a switch receiver.

It is another objective of the present invention to provide a dual tank beard care multi-tool that may comprise a first tank.

It is another objective of the present invention to provide a dual tank beard care multi-tool that may comprise a second tank.

It is another objective of the present invention to provide a dual tank beard care multi-tool that may comprise a plurality of tank receivers.

It is another objective of the present invention to provide a dual tank beard care multi-tool that may comprise a switched beard comb.

It is another objective of the present invention to provide a dual tank beard care multi-tool that may comprise a switched beard comb receiver.

It is another objective of the present invention to provide a dual tank beard care multi-tool that may comprise a folding comb.

It is another objective of the present invention to provide a dual tank beard care multi-tool that may comprise a folding comb receiver.

It is another objective of the present invention to provide a dual tank beard care multi-tool that may comprise a scissor.

It is another objective of the present invention to provide a dual tank beard care multi-tool that may comprise a scissor receiver.

It is another objective of the present invention to provide a dual tank beard care multi-tool that may comprise a beard brush.

It is another objective of the present invention to provide a dual tank beard care multi-tool that may comprise a beard brush receiver.

It is another objective of the present invention to provide a dual tank beard care multi-tool that may comprise a mirror.

It is another objective of the present invention to provide a dual tank beard care multi-tool that may comprise a heating element.

It is another objective of the present invention to provide a dual tank beard care multi-tool that may comprise a resilient material of construction.

It is another objective of the present invention to provide a dual tank beard care multi-tool that may comprise a water-proof material of construction.

It is another objective of the present invention to provide a dual tank beard care multi-tool that may comprise a reusable material of construction.

It is another objective of the present invention to provide a dual tank beard care multi-tool that may comprise a washable material of construction.

It is another objective of the present invention to provide a dual tank beard care multi-tool that may comprise a multi-component construction.

It is another objective of the present invention to provide a dual tank beard care multi-tool that may comprise an antimicrobial layer.

It is another objective of the present invention to provide a dual tank beard care multi-tool that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is an isometric perspective view of a dual tank beard care multi-tool, as contemplated by the present disclosure;

FIG. 2 is an isometric perspective view of a dual tank beard care multi-tool, as contemplated by the present disclosure;

FIG. 3 is a top plan view of a dual tank beard care multi-tool, as contemplated by the present disclosure;

FIG. 4 is a front elevation view of a dual tank beard care multi-tool, as contemplated by the present disclosure;

FIG. 5 is a bottom plan view of a dual tank beard care multi-tool, as contemplated by the present disclosure;

FIG. 6 is a bottom plan view of a dual tank beard care multi-tool with beard brush removed, as contemplated by the present disclosure;

FIG. 7 is an isometric perspective view of a dual tank beard care multi-tool with switched comb extended, as contemplated by the present disclosure;

FIG. 8 is a top plan view of a dual tank beard care multi-tool with switched comb extended, as contemplated by the present disclosure;

FIG. 9 is an exploded isometric perspective view of a dual tank beard care multi-tool showing a removable first tank, removable second tank, and removable beard brush, as contemplated by the present disclosure;

FIG. 10 is an exploded isometric perspective view of a dual tank beard care multi-tool showing a removable folding comb, removable scissor, and disassembled switch and switched comb components, as contemplated by the present disclosure;

FIG. 11 is an isometric perspective view of a second tank of a dual tank beard care multi-tool, as contemplated by the present disclosure;

FIG. 12 is an isometric perspective view of a second tank with lid opened of a dual tank beard care multi-tool, as contemplated by the present disclosure;

FIG. 13 is an isometric perspective view of a first tank of a dual tank beard care multi-tool with twist-off lid twisted, as contemplated by the present disclosure;

FIG. 14 is an isometric perspective view of a first tank of a dual tank beard care multi-tool with twist-off lid separated, as contemplated by the present disclosure;

FIG. 15 is an isometric perspective view of a folding comb of a dual tank beard care multi-tool, as contemplated by the present disclosure;

FIG. 16 is an isometric perspective view of a folding comb of a dual tank beard care multi-tool unfolded, as contemplated by the present disclosure;

FIG. 17 is an isometric perspective view of a scissor of a dual tank beard care multi-tool, as contemplated by the present disclosure; and

FIG. 18 is an isometric perspective view of a scissor of a dual tank beard care multi-tool with cutting edges opened, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The dual tank beard care multi-tool is intended to be carried by a user and provide a mobile source of beard care grooming tools. The device provides two distinct tanks, one may be for oils and one may be for balms, and a plurality of tools required by beard wearers. Among these tools may be a switched beard comb, which may be manually or semi-automatically switched so that a user may carry the device without the comb teeth being exposed. The first tank and second tank may be integrated into the device main body or may be removably attached. The device may further comprise a plurality of receivers for receiving a folding comb, a scissor, and a beard brush. A mirror may also be installed within the device, and a heating element may be incorporated in some embodiments.

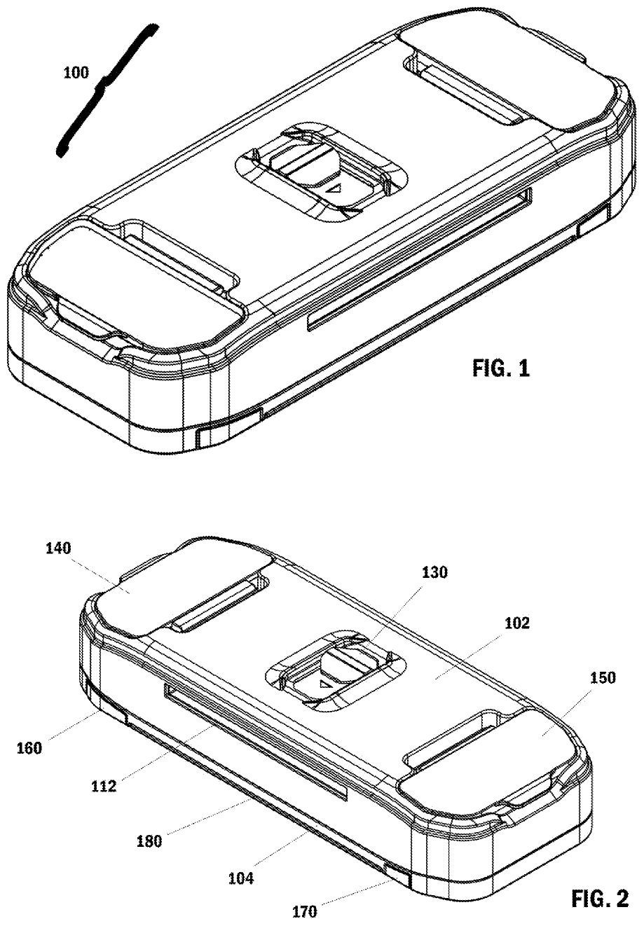

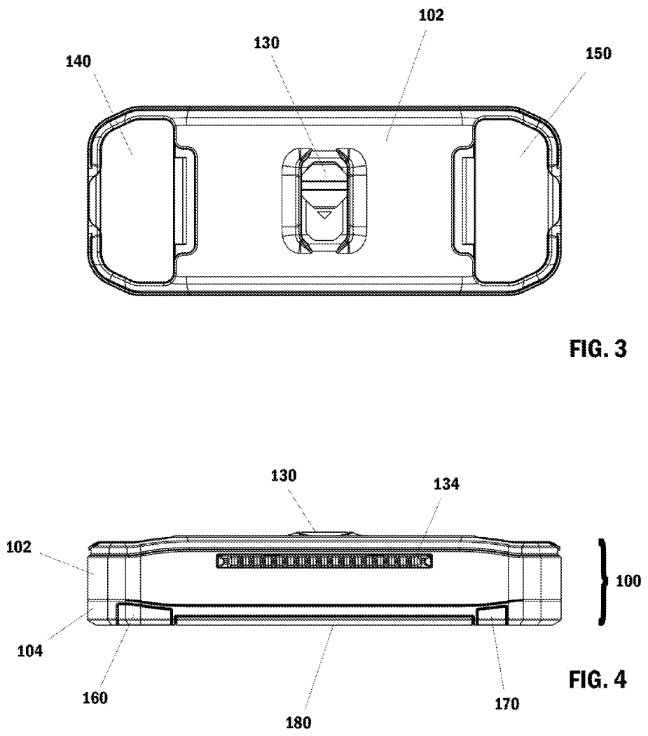

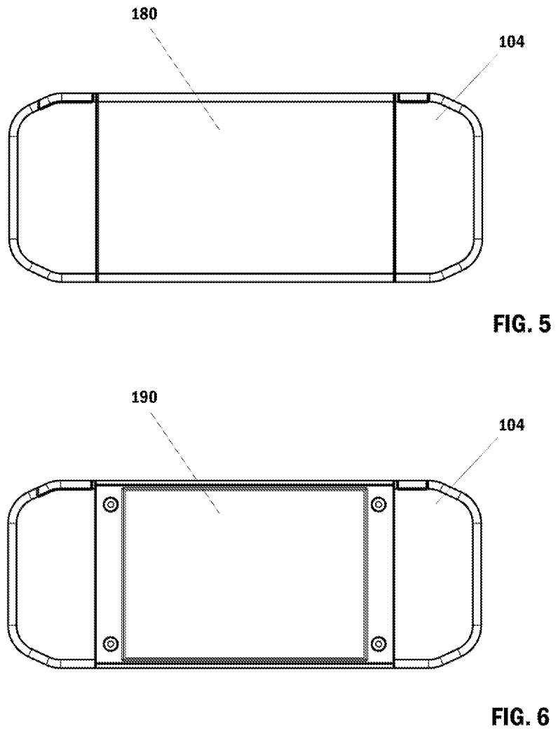

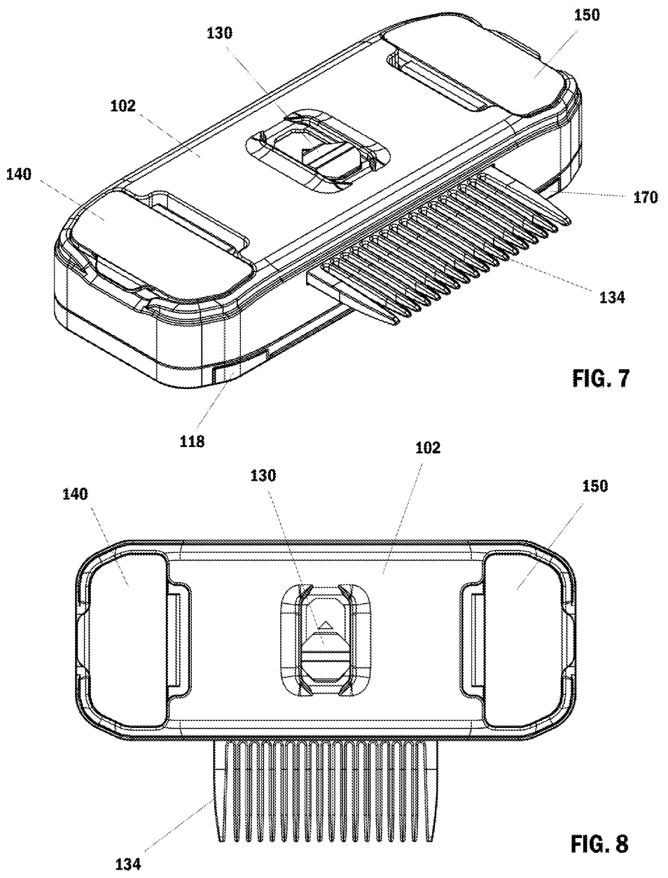

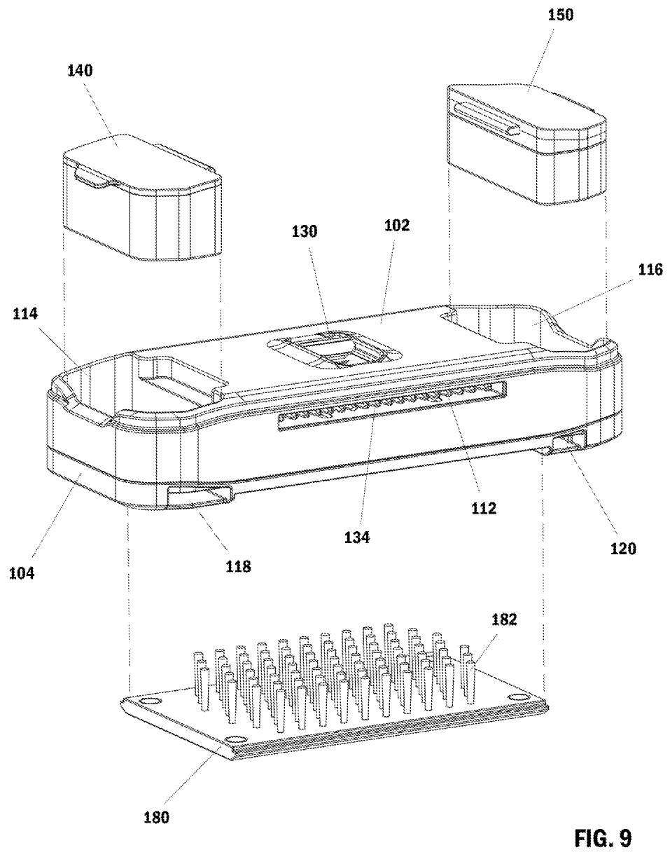

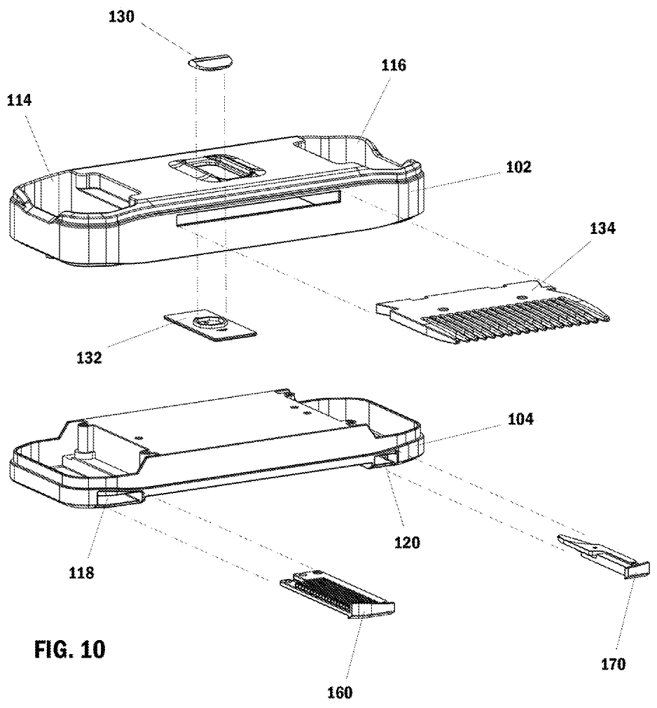

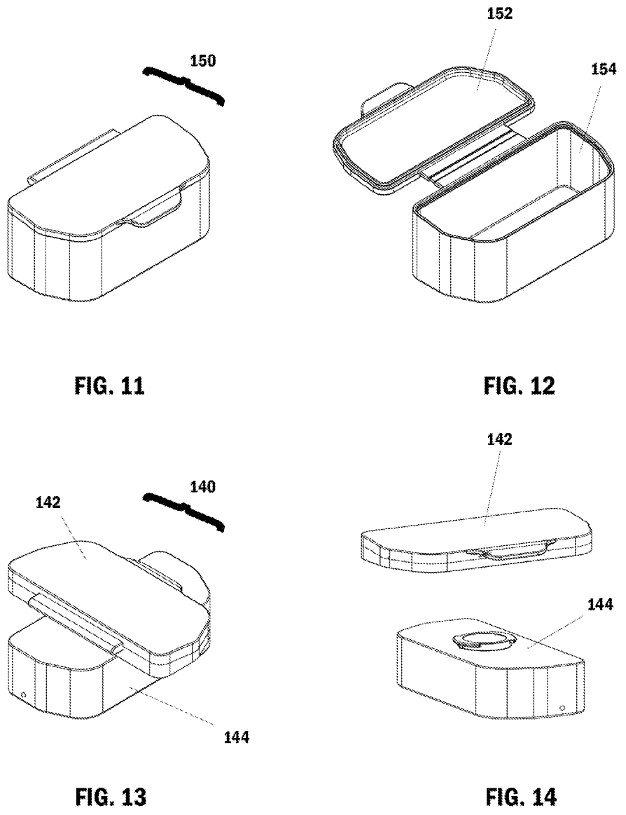

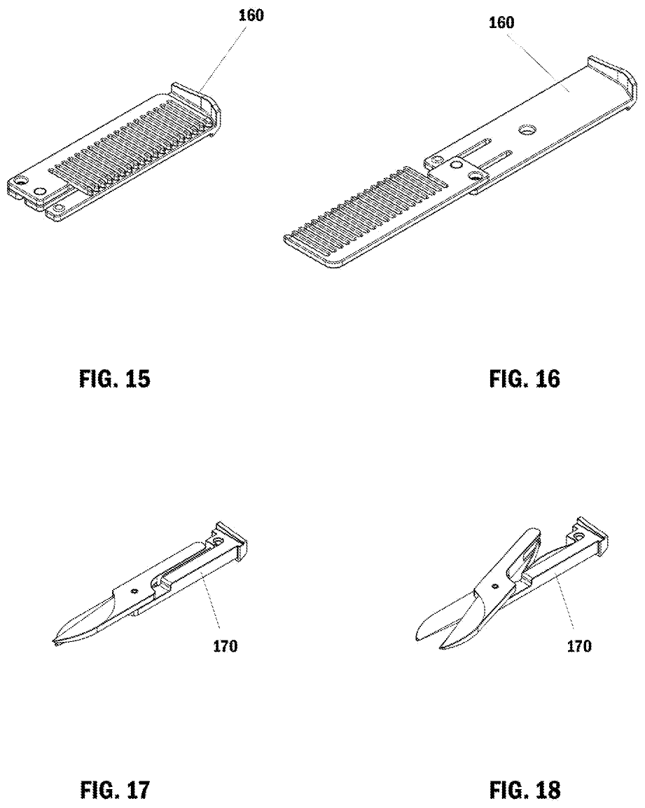

The illustrations of FIGS. 1-18 illustrate a dual tank beard care multi-tool, as contemplated by the present disclosure. The device may comprise, generally, a main body 100, a switched comb 134, a first tank 140, and a second tank 150. The main body 100 may comprise any shape appropriate for carrying by a user in a hand and in a clothing pocket such as, for example, a disc, square, or rectangle shape having a thickness. The switched comb 134 may be integrated into the main body 100 such that it is manually or semi-automatically extended and retracted relative to the main body 100, and such that the switched comb 134 is contained within the main body 100 when retracted. The first tank 140 and second tank 150 may be integrated into the main body 100 such that they provide storage for an appropriate fluid and an appropriate semi-fluid, respectively, without interfering with the extension and retraction of the switched comb 134.

In one embodiment the main body 100 may comprise a substantially rectangular shape having a thickness, and may further comprise an upper body 102 and a lower body 104. The upper body 102 and lower body 104 may combine to create the main body 100, and a sled or other appropriate mechanism may be attached to the switched comb 134 and sandwiched between the upper body 102 and lower body 104. The upper body 102 and lower body 104 may be attached to each other by any appropriate means such as, for example, fastening with screws, bolts, or rivets, gluing, or welding. The upper body 102 or lower body 104 may further comprise a switched comb receiver 112, which may be an opening in a side of the upper body 102 or lower body 104 appropriate for allowing a plurality of teeth of the switched comb 134 to protrude from the main body 100.

The sled or other appropriate mechanism may be attached to the switched comb 134 by any appropriate means such as, for example, fastening with screws, bolts, or rivets, gluing, or welding. The sled or other appropriate mechanism may further comprise a manual slotting or locking device or a spring loaded and locking mechanism to prevent unintended extension or retraction of the switched comb 134. The upper body 102 or lower body 104 may further comprise a switch receiver 110 into which a switch 130 and switch base 132 combination may be installed. The switch 130 and switch base 132 combination may be attached to the sled or other appropriate mechanism of the switched comb 134 to facilitate or direct the extension or retraction of the switched comb 134. The sled or other appropriate mechanism may be attached to the switch 130 and switch base 132 combination by any appropriate means such as, for example, fastening with screws, bolts, or rivets, gluing, or welding.

The first tank 140 of the dual tank beard care multi-tool may comprise any appropriate hollow shape suitable for storing beard oil, cologne, or any other appropriate fluid. The first tank 140 may further comprise a first tank lid 142 and a first tank body 144, and may integrate an appropriate mechanism for providing a fluid-tight seal when the first tank lid 142 is closed. The first tank lid 142 may further comprise a two-piece lid and base combination attached to the first tank body 144 by a twist-off mechanism. The first tank body 144 may further comprise a mechanism for refilling and for dispensing an appropriate liquid relative to the first tank 140. By way of example, the first tank 140 may comprise a pour spout, which may dispense and meter an appropriate liquid from the first tank body 144. The first tank lid 142 may further comprise a seal or projection for specifically blocking the pour spout. In one embodiment the first tank 140 may be removably attached to the main body 100, and may be installed within a first tank receiver 114, which may comprise an appropriately shaped recess or depression within the main body 100.

The second tank 150 of the dual tank beard care multi-tool may comprise any appropriate hollow shape suitable for storing beard balm, pomade, lotion, or any other appropriate semi-fluid. The second tank 150 may further comprise a second tank lid 152 and a second tank body 154, and may integrate an appropriate mechanism for providing a fluid-tight seal when the second tank lid 152 is closed. The second tank body 154 may further comprise a mechanism for refilling and for dispensing an appropriate semi-fluid relative to the second tank 150. By way of example, the second tank 150 may comprise an open top, which may allow a user to dispense an appropriate semi-fluid from the second tank body 154. In one embodiment the second tank 150 may be removably attached to the main body 100, and may be installed within a second tank receiver 116, which may comprise an appropriately shaped recess or depression within the main body 100.

The dual tank beard care multi-tool may further comprise a folding comb receiver 118, which may be an opening in a side of the upper body 102 or lower body 104 appropriate for receiving a folding comb 160 within the main body 100. The folding comb 160 may comprise a two-piece comb design having a comb head and a comb handle attached to each other by a mechanism appropriate for allowing one component to articulate relative to the other. The degree of articulation may vary from zero to one hundred and eighty degrees so that the folded embodiment of the folding comb 160 is approximately one half of the length of the extended embodiment of the folding comb 160. The base of the folding comb 160 may be designed such that it creates a seal with the main body 100 when the folding comb 160 is installed, and the mechanism of attachment may comprise any appropriate mechanism such as, for example, a magnetic bond, a friction fit, a snap fit, or a spring-loaded mechanism.

The dual tank beard care multi-tool may further comprise a scissors receiver 120, which may be an opening in a side of the upper body 102 or lower body 104 appropriate for receiving a scissor 170 within the main body 100. The scissor 170 may comprise a two-piece scissor design having two opposed cutting blades attached to each other by a mechanism appropriate for allowing one cutting edge to articulate towards and away from the other. The degree of articulation may vary from zero to forty-five degrees so that the closed embodiment causes the opposing cutting edges to overlap while the opened embodiment separates the two cutting edges. The base of the scissor 170 may be designed such that it creates a seal with the main body 100 when the scissor 170 is installed, and the mechanism of attachment may comprise any appropriate mechanism such as, for example, a magnetic bond, a friction fit, a snap fit, or a spring-loaded mechanism.

The dual tank beard care multi-tool may further comprise a brush receiver 122, which may be an opening in a side of the upper body 102 or lower body 104 appropriate for receiving a brush 180 within the main body 100. The brush 180 may comprise a substantially flat surface having a plurality of bristles 182 projecting therefrom. The substantially flat surface of the brush 180 may have an outer surface that is aesthetically identical to an outer surface of the main body 100, and may act as a secondary outer wall of the main body 100 when the brush 180 is installed in the main body 100. When installed, the bristles 182 of the brush 180 may project into a central cavity of the main body 100 so that a user may carry the device without the bristles 182 being exposed. The base of the brush 180 may be designed such that it creates a seal with the main body 100 when the brush 180 is installed, and the mechanism of attachment may comprise any appropriate mechanism such as, for example, a magnetic bond, a friction fit, a snap fit, or a spring-loaded mechanism.

The dual tank beard care multi-tool may further comprise a mirror 190, which may be any appropriately shaped mirror suitable for personal viewing by a user. The mirror 190 may be attached to an outer surface of the main body 100 or may be attached to an inner surface of the main body 100. In one embodiment the mirror 190 may be attached with the central cavity of the main body 100 into which the bristles 182 of the brush 180 project. The mechanism of attachment of the mirror 190 may comprise any appropriate mechanism such as, for example, fastening with screws, bolts, or rivets, gluing, or welding.

The dual tank beard care multi-tool may further comprise a heating element, which may be any appropriately shaped heating element suitable for creating and transmitting heat to a component of the device, as desired. The heating element may be installed in or near the first tank 140 and second tank 150 such that a user may activate the heating element to warm up the oil in the first tank 140 or the balm in the second tank 150. The heating element may be installed in or near the switched comb 134 such that a user may activate the heating element to warm up the switched comb 134.

The dual tank beard care multi-tool may be substantially constructed of any suitable material or combination of materials, but typically is constructed of a resilient material or combination of materials such that the device is resistant to damage as a result of compression, twisting, heating, or submersion in water. As an example, and without limiting the scope of the present invention, various exemplary embodiments of the dual tank beard care multi-tool may be substantially constructed of one or more materials of plastic, acrylic, polycarbonate, steel, aluminum, brass, fiberglass, carbon fiber, or combinations thereof. In some embodiments the various components of the device may be coated, lined, or otherwise insulated to prevent contamination of the device. In one embodiment the material of construction may vary from one component to the next within the system.

In one embodiment the dual tank beard care multi-tool may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A dual tank beard care multi-tool, comprising:
a main body;
a switched comb;
a first tank; and
a second tank;
wherein said switched comb is contained within said main body when in a retracted position; and
wherein a plurality of teeth of said switched comb project from said main body when in an extended position.

2. The invention of claim 1,
a switch and switch base combination;
wherein said switch and switch base combination is attached to said switched comb; and
wherein manipulation of said switch and switch base combination causes said switched comb to alternately extend and retract.

3. The invention of claim 2, further comprising:
wherein said first tank further comprises a first tank lid and a first tank body;
wherein said second tank further comprises a second tank lid and a second tank body;
wherein said first tank lid provides a fluid-tight seal to said first tank body;
wherein said first tank body stores an appropriate fluid;
wherein said second tank lid provides a fluid-tight seal to said second tank body; and
wherein said second tank body stores an appropriate semi-fluid.

4. The invention of claim 3, further comprising:
a switched comb receiver;
wherein said switched comb receiver comprises an opening in a side of said main body;
wherein said plurality of teeth of said switched comb project from said switched comb receiver when said switched comb is in an extended position.

5. The invention of claim 4, further comprising:
a brush; and
a brush receiver;
wherein said brush is removably attached to said brush receiver.

6. The invention of claim 5, further comprising:
a folding comb; and
a folding comb receiver;
wherein said folding comb is removably attached to said folding comb receiver.

7. The invention of claim 6, further comprising:
a scissor; and
a scissor receiver;
wherein said scissor is removably attached to said scissor receiver.

8. The invention of claim 7, further comprising:
a mirror;
wherein said mirror is attached to said main body.

9. The invention of claim 8,
wherein said main body further comprises an upper body and a lower body.

10. The invention of claim 9,
wherein said first tank is removably attached to said main body; and
wherein said second tank is removably attached to said main body.

11. The invention of claim 10,
wherein said first tank is removably installed within a first tank receiver in said main body; and
wherein said second tank is removably installed within a second tank receiver in said main body.

12. The invention of claim 11,
wherein said switch and switch base combination is installed within a switch receiver in said main body.

13. The invention of claim 12,
wherein said brush further comprises a plurality of bristles; and
wherein said plurality of bristles project into said main body when said brush is installed.

14. The invention of claim 13,
wherein said folding comb projects into said main body when said folding comb is installed.

15. The invention of claim 14,
wherein said scissor projects into said main body when said scissor is installed.
